(19) United States
(12) Patent Application Publication
(10) Pub. No.: US 2003/0222921 A1
(43) Pub. Date: Dec. 4, 2003

(54) Automatic layout generation using algorithms

(76) Inventor: Bernard Rummel, Schriesheim (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/293,451

(22) Filed: Nov. 13, 2002

Related U.S. Application Data
(60) Provisional application No. 60/386,106, filed on Jun. 4, 2002.

(51) Int. Cl. G09G 5/00; G06F 7/00

(52) U.S. Cl. 345/788

(57) ABSTRACT

Automatic layout generation using algorithms taking into account a size of the layout and sizes of elements to be placed in the layout. Longer elements may be placed on separate rows of the layout, while shorter elements are distributed in a number of columns. Elements may be placed in group boxes, and an initial distribution of group boxes may be redistributed or adjusted to reduce the required screen space, to increase symmetry, and/or to avoid misleading semantics.

### CROSS-REFERENCE TO RELATED APPLICATIONS

This application claims benefit from U.S. Provisional Application Ser. No. 60/386,106, filed Jun. 4, 2002 and entitled “Methods and Apparatus for Automatic Form Generation,” which is incorporated by reference in its entirety. Pending U.S. Application Ser. No. 10/232,942 filed Aug. 30, 2002 and entitled “Automatic Layout Generation” also claims benefit from said provisional and is incorporated by reference in its entirety.

### TECHNICAL FIELD

The invention relates to generating layouts for display on computer screens or other display terminals.

### BACKGROUND

Many computer applications use visual user interfaces. A graphical user interface includes one or more graphical elements in a layout for display on a computer screen. The graphical elements are associated with the function(s) of the computer application and may include buttons, text entry fields, labels, checkboxes, drop-down menus, etc. The graphical elements in the layout provide data input from, and data output to, the user, for example by the user clicking on a button, entering data in a field or reading text in a message box.

The order of the graphical elements in the layout may be important for several reasons. First, a certain layout design may affect users' ability to learn and operate the program. Second, inefficient use of screen area (sometimes referred to as “real estate” in this context) may force a user to scroll the screen to see the entire layout. Alternatively, inefficient use of real estate may cause an unnecessary number of layouts to be included in the application. This, in turn, may increase storage demands and slow down operation.

Layouts are typically generated by manual processes. The graphical elements that should be provided in the user interface are often identified during the development of the application. The developer may then generate the layout by placing the graphical elements in order on an empty sheet. When the layout is finished, it is stored together with the computer application so that it can be displayed during operation.

Creating layouts manually may have disadvantages. For example, efficiency and quality may be affected by factors such as the cost of the employee, the time required to finish the work, and the risk for mistakes. If several people create layouts for a project, it may also be difficult to maintain a consistent appearance between the different layouts.

Attempts have been made to automate the generation of forms for computer applications. One such attempt is an application that takes an existing table of elements and generates a form by automatically placing the elements from the table one after the other in a column. This solution may lead to an inefficient use of real estate because it does not take the elements' sizes into account when placing them in the layout.

Another automation attempt focuses on customizing existing layouts by removing elements. The user decides which elements should no longer be included in the layout and causes the user interface to delete them. The user interface may then compress the layout from the bottom towards the top to preserve some of the real estate occupied by these elements. This solution may not provide an initial layout and the compression may disturb the relation between elements.

Layouts may also present issues when it comes to customizing a finished system. Many computer systems are sold with pre-generated user interfaces where the customer (user) cannot modify forms that are displayed on the screen. Moreover, systems that allow modification of forms may not support the customization process sufficiently that the user can create functional and esthetically acceptable layouts.

### SUMMARY

The invention relates to automatic generation of layouts. In one general aspect, the invention provides a method of generating a layout for a computer user interface. A plurality of elements to be placed in a layout are received. The elements are distributed in the layout according to an algorithm taking into account sizes of the elements and a size of the layout.

In selected embodiments of this first aspect, the relative sizes of elements are taken into account in the distribution. Longer elements may be placed on separate rows of the layout, while shorter elements may be distributed in a number of columns.

In a second general aspect, elements to be placed in the layout are located in group boxes. One or more group boxes may be automatically redistributed and/or adjusted to reduce the overall size of the layout, to symmetrize the layout, and/or to avoid undesirable layouts. In selected embodiments of this second aspect, the relative sizes of group boxes are taken into account. In an initial layout including three group boxes side-by-side with a single group box beneath them, one of the three group boxes may be relocated next to the fourth one if height differences between the four group boxes, and an overall height of the layout, meet predetermined criteria.

Advantages of the invention may include one or more of the following. Automatically generating layouts eliminates the differences sometimes introduced by manual layout generation, and may be less expensive and time-consuming. Reducing the required screen space may make the generated layouts more useful in situations where a large screen is impracticable. Increasing layout symmetry may make the layout easier to learn and use as well as more visually appealing. Avoiding undesirable layouts may reduce unintended suggestions of relationships among elements and group boxes, respectively. Embodiments of the invention may be used in connection with modifying existing user interfaces of computer systems. This may allow an owner of a computer system to automatically generate layouts when customizing an existing user interface.

### BRIEF DESCRIPTION OF DRAWINGS

FIG. 1 is a block diagram of a computer system including a layout generating module;

FIG. 2 are examples of layout elements;

FIG. 3 is examples of layouts of different widths;

FIG. 4A is an example of elements to be placed in the layout;

FIG. 4B is an example of placing the elements in the layout of FIG. 4A;

FIG. 5 is a flow chart of steps that may be carried out by the system in FIG. 1;

FIG. 6A is another example of elements to be placed in the layout;

FIG. 6B is an example of placing the elements of FIG. 6A in a layout;

FIG. 6C is another example of placing elements in a layout;

FIG. 7A is another example of elements to be placed in a layout;

FIG. 7B is an example of placing the elements in the layout of FIG. 7A;

FIG. 8 is an example of group boxes placed in a layout;

FIG. 9 is another flow chart of steps that may be carried out by the system in FIG. 1;

FIG. 10 is another flow chart of steps that may be carried out by the system in FIG. 1;

FIGS. 11A-B are examples of group boxes placed in a layout; and

FIGS. 12A-C are examples of size-adjusted group boxes in a layout.

Like reference symbols in the various drawings indicate like elements.

### DETAILED DESCRIPTION

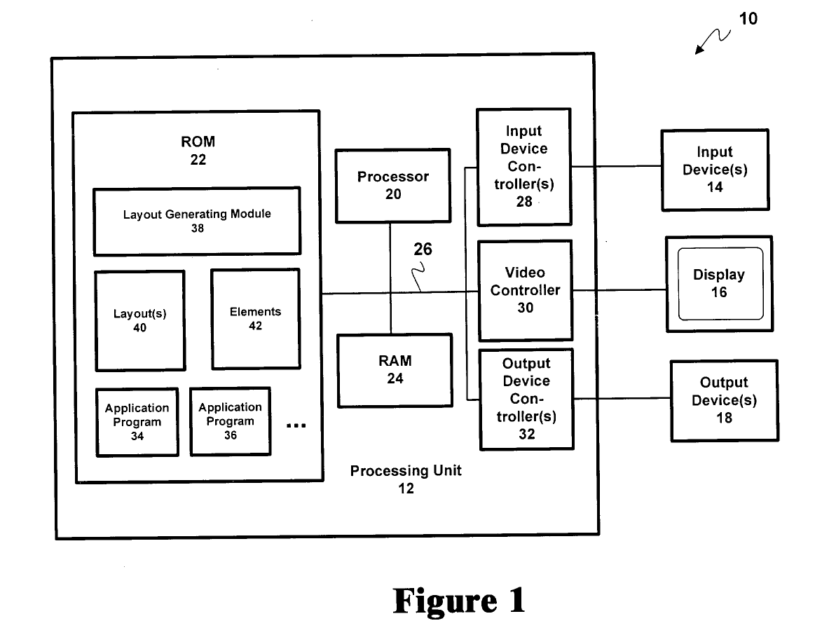

A computer system 10, shown in FIG. 1, includes a processing unit 12, one or more input devices 14, and a display device 16 upon which layouts generated in accordance with the invention can be displayed. The computer system 10 also includes one or more output devices 18 for outputting generated layouts.

As is conventional, the processing unit 12 includes a processor 20, read-only memory (ROM) 22, and random access memory (RAM) 24, all interconnected by a data bus 26. Input device controllers 28, also connected to the data bus 26, receive command signals from input devices 14 and forward the command signals in the appropriate format for processing. A video controller 30, connected to the data bus 26, receives video command signals from the data bus 26 and generates the appropriate video signals that are forwarded to the display device 16. Output device controller 32 receives signals from the data bus 26 and generates the appropriate output signals that are forwarded to the output device(s) 18. The computer system 10 is not limited to a personal computer, but could instead include a personal digital assistant, a server, a terminal, a workstation, or other such device.

ROM 22, as is conventional, provides non-volatile data storage for various application programs. In the example shown in FIG. 1, exemplary application programs 34, 36, etc., are stored in ROM 22. Also stored in ROM 22 is a layout generating module 38 designed to generate one or more layout(s) 40 using elements 42 as will be described below. The application programs 34, 36, etc. use layout(s) 40 in their user interfaces for interaction with users. These components could be combined or separated in various manners, and could be stored in various manners, such as on various non-volatile storage media.

The layout generating module 38 typically includes software code written in a suitable programming language. As is conventional, programs 34, 36, 38, etc. have program instructions that may be loaded into RAM 24 during operation. Processor 20 then executes the program instructions, as required, to perform desired program functions.

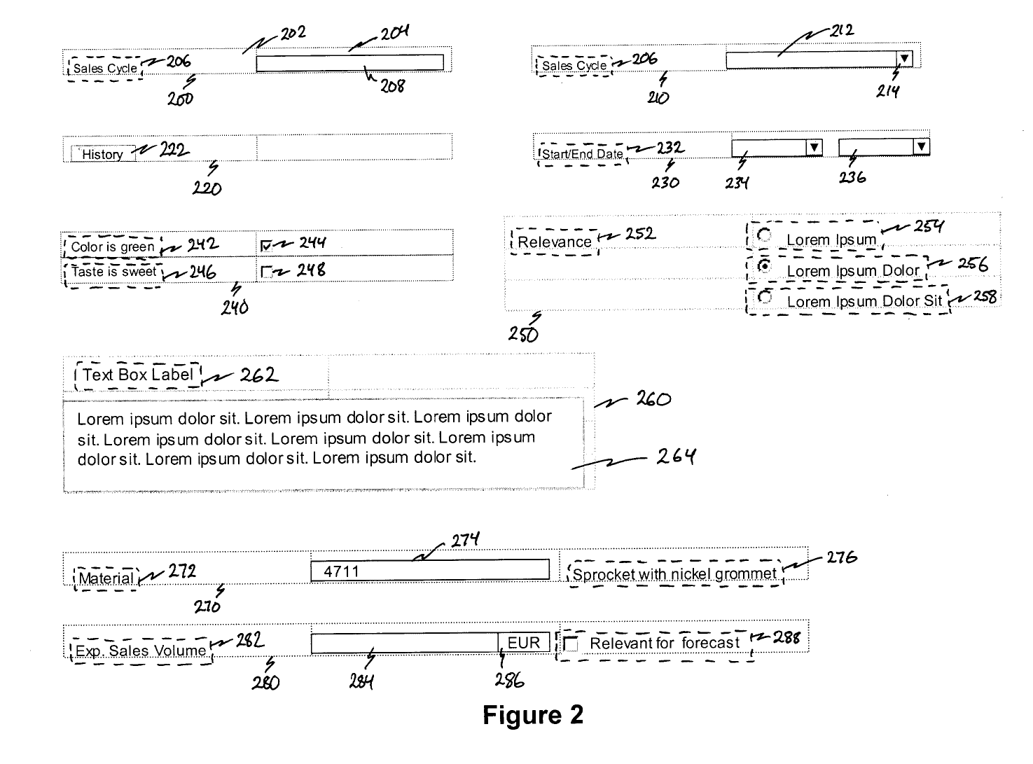

Elements used in generating layouts, sometimes referred to as layout elements, are visual features that are included in a layout to serve particular purposes. FIG. 2 shows exemplary layout elements. When the layout is used in the user interface of a computer application, layout elements may be displayed on a screen to facilitate input and output of data.

Element 200 is an example of an entry-field element. The element 200 covers two cell units 202 and 204. A label “Sales Cycle” is included in the cell unit 202. A character-entry field 208 is included in cell unit 204. When element 200 occurs in a layout, a user may refer to the label 206 to determine what kind of data may be entered in field 208. The user may enter data in a suitable format by typing in, pasting into, or otherwise placing characters in entry field 208. Element 210 is an example of a list box element. In this example, element 210 has the label 206 in the left cell unit and a field 212 in the right cell unit. When a user activates a list selection icon 214, a list appears below the field 212. When the user selects an item from the list, it is shown in the field 212.

Elements may include buttons that the user can activate. Element 220 is an example of a single-button element with a button 222 in the left cell unit. The button contains the label “History.” Elements may include more than one button.

Element 230 is an example of a pair of short fields. Element 230 includes the label “Start/End Date” 232 in the left cell unit and two fields 234 and 236 in the right cell unit. Similar to the function of element 210, the user may select, as an input, items from lists that appear below the fields 234 and 236 (here, dates, for example).

Elements may contain other selection mechanisms such as checkboxes. Element 240 is an example of a checkbox element having a first label 242 associated with a first checkbox field 244, and a second label 246 associated with a second checkbox field 248. In this example, the first checkbox field 244, but not the second checkbox field 248, has been selected. This is a complementary checkbox where a user can select none, one, or both of the checkbox fields 244 and 248.

Element 250 is an example of a multiple-choice element sometimes referred to as a radio button group. The element 250 contains a label 252 to the left of three labeled radio buttons 254, 256 and 258. Here, the radio button 256 has been selected. It is noted that the radio buttons in element 250 are labeled on their right sides, and that the checkboxes in element 240 are labeled on their left sides. Other placements of the labels are possible. It will also be understood that elements can include checkboxes or radio button groups with more alternatives than shown in FIG. 2.

Element 260 is an example of a text box element. The element 260 includes a label 262 above a text edit box 264. The element 260 permits the user to enter text (or other characters) in the text edit box 264 or edit text that appears there, for example.

Element 270 is an example of a combination of a field with an associated text. Element 270 includes label 272 and an entry field 274. A text 276, sometimes referred to as an inspection text, is associated with the category of information to be entered in the entry field 274 and is located in the cell unit to the right thereof. Element 280 is another example of a combination element that has a label 282, an entry field 284 with a unit “EUR” 286, and a checkbox element 288. A user reads the label 282 to understand that this input relates to “Exp. Sales Volume” and makes the appropriate input in field 284 (here, a sales volume measured in euros, for example). The user may select checkbox element 288 if the entered information is “Relevant for forecast.”

The elements in FIG. 2 are modular, meaning that they are based on a system with a common unit width. Elements will be created in (or later be modified to) multiples of this unit width. Elements in different embodiments of the invention may be based on different unit widths. It is seen that the elements in FIG. 2 correspond to two, three, four or more cell units, respectively. One-cell elements may be used. Some of the exemplary elements have a text label in the left cell and one or more input mechanisms to the right of the label. In other embodiments the label may be placed differently, such as above the input like in the element 260, or omitted.

Also, element 250 is taller than some of the other exemplary elements in FIG. 2. Since the label 252 and the three radio buttons 254, 256 and 258 are taller than two cell units, the element 250 is expanded to the size of three cell units as shown.

The layout generating module 38 generates a layout 40 using elements 42. The elements 40 may have been stored in ROM 22 by a developer who decided that these respective elements should be included in the user interface for one of the application programs 34, 36, etc. Thereby, the developer can avoid the often time-consuming process of assembling the elements into a layout. Rather, the developer may select the appropriate layout elements from an available source, such as a database library, to have the layout(s) be generated by layout generating module 38. As another example, the computer system 10 may include a customizable user interface for the benefit of its users. A user can run the layout generating module 38 to create new, or modify existing, layouts to serve the user's needs.

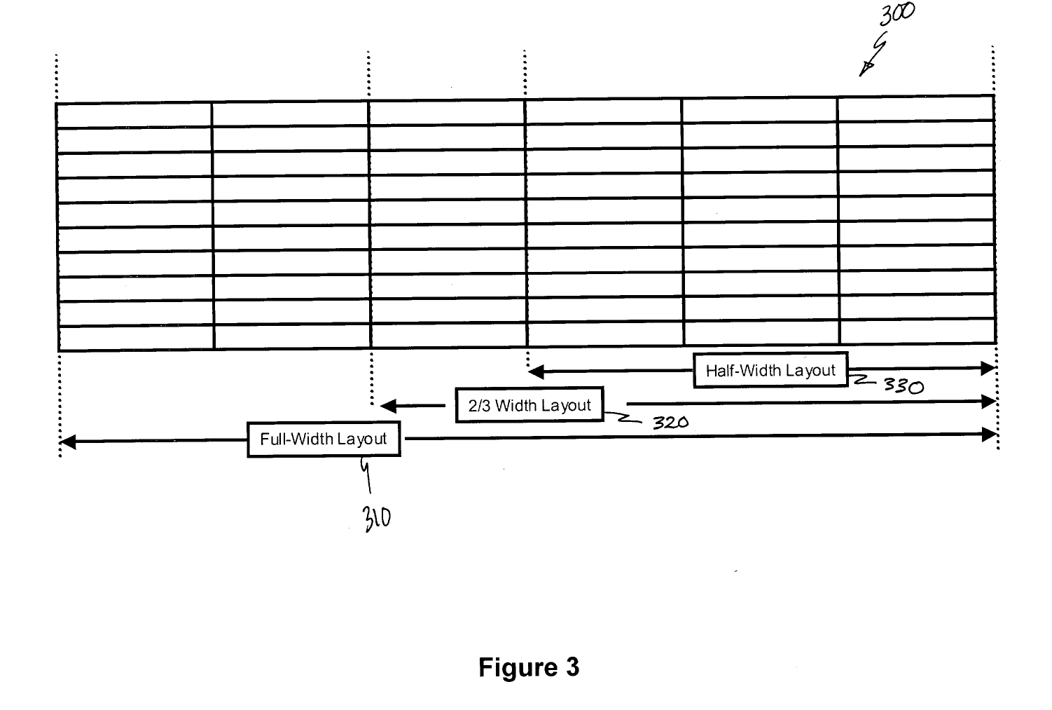

The layouts 42 are based on a grid containing cells corresponding to the cell units of the layout elements. FIG. 3 shows an exemplary grid 300 that is six cells wide. In a system using the grid 300, a six-cell layout 310 may conveniently be referred to as a Full-Width Layout. Similarly, four-cell layouts 320 may be referred to as a ⅔ Width Layout, and a three-cell layout 330 as a Half-Width Layout, respectively. Which size layout to use may be determined by the characteristics of the application programs 34, 36, etc. where the layout is to be used, and also by the intended size and type of the display 16. For clarity, the layouts 310, 320, 330 and others in this description will be represented as visible grids in this and later figures. However, it should be understood that typically, only the layout elements are visible on the display 16.

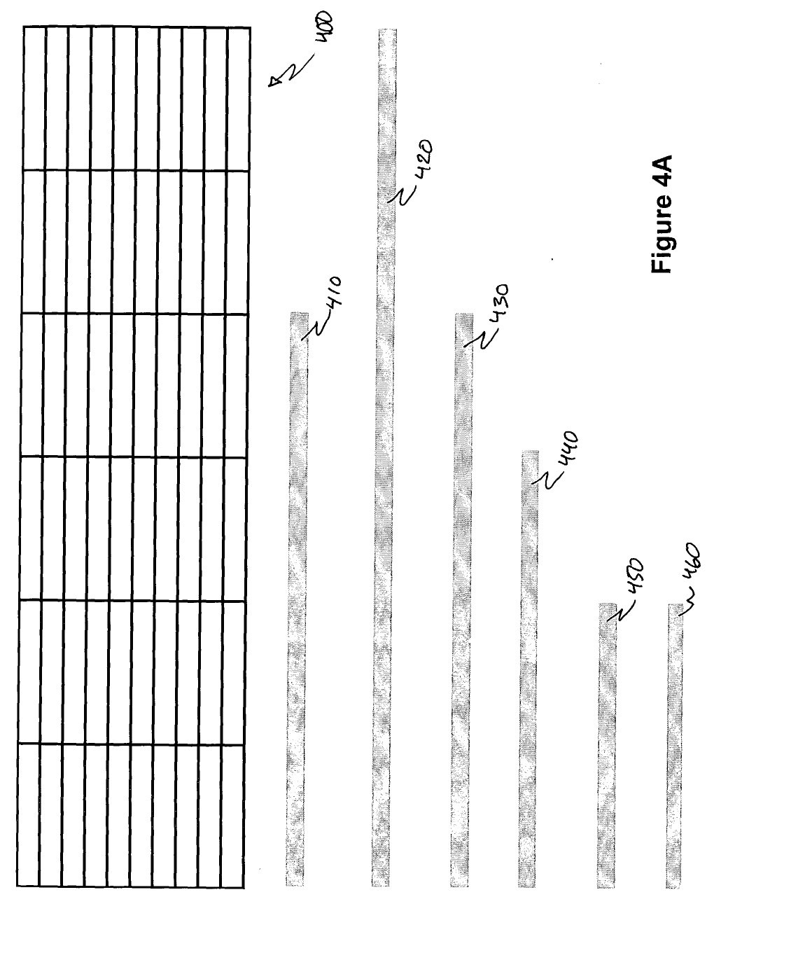

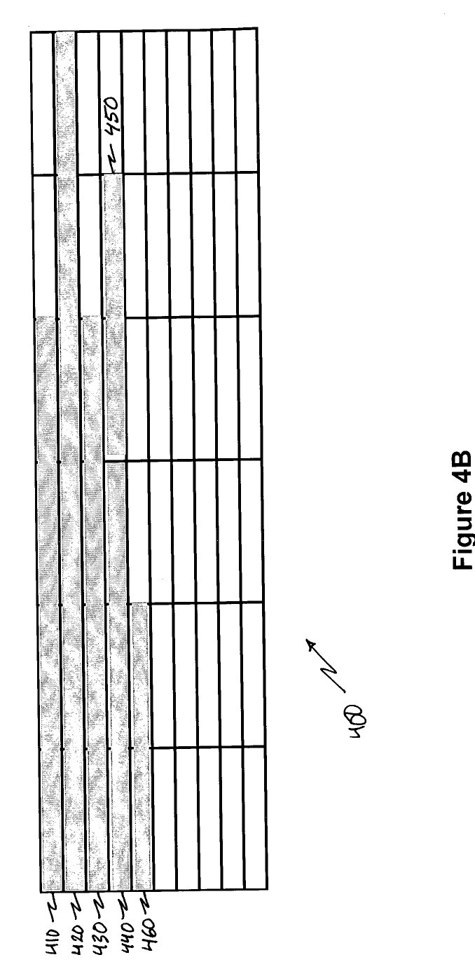

The layout generating module (LGM) 38 uses one or more algorithms to place the elements 42 in the layout. Such algorithms take into account the size of the intended layout and the size(s) of the elements to be placed therein. FIG. 4A shows an exemplary six-cell layout 400. Elements 42 to be placed in this layout include element 410 (four cells wide), element 420 (six cells), element 430 (four cells), element 440 (three cells), and elements 450 and 460 (each two cells wide).

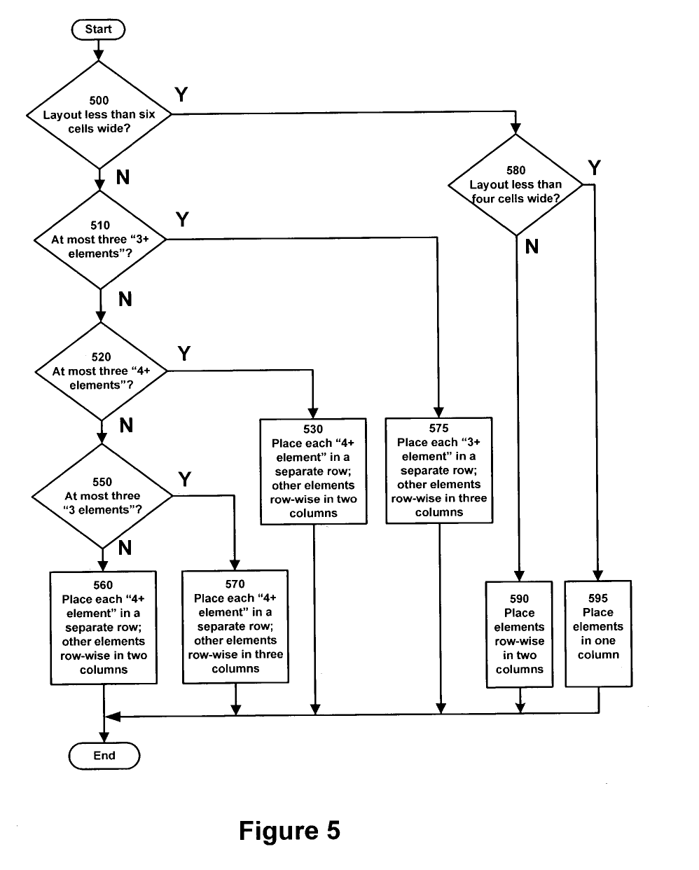

With reference also to FIGS. 4B and 5, an example of how the LGM 38 places the elements 42 in the layout 400 will now be described. The process performed by the processor 20 executing instructions from the LGM 38 begins, at step 500 in FIG. 5, by determining whether the intended layout will be less than six cells wide. The layout 400 in this example is six cells wide, so the answer to the inquiry is no.

In step 510, the LGM analyzes the elements 42 to determine how many are three cells wide or more. For brevity, FIG. 5 refers to elements that are three or more cells wide as “3+ elements.” There are four “3+ elements” in this example (410, 420, 430 and 440), so the answer in step 510 is no.

In step 520, the LGM determines how many of the elements 42 are four cells wide or more. FIG. 5 refers to such elements as “4+ elements.” The answer in step 520 will be yes if there are at most three “4+ elements.” There are three “4+ elements” in this example (410, 420 and 430), so step 520 is answered in the affirmative.

In step 530, the LGM 38 distributes the elements 42 in the layout 400 by placing each “4+ element” in a separate row and the remaining elements row-wise in two columns. With a six-cell grid like the exemplary layout 400, the LGM 38 may begin the first column at the left of the layout, and the second column at the middle. FIG. 4B shows the layout 400 after all of the elements 42 in this example have been distributed. It is seen that the “4+ elements” 410, 420 and 430 are placed on separate rows. Elements 440, 450 and 460 are placed in two columns beginning with element 440. The LGM 38 places element 450 in the column to the right of element 440. The LGM 38 then places element 460 at the beginning of the following row, and the process in FIG. 5 ends.

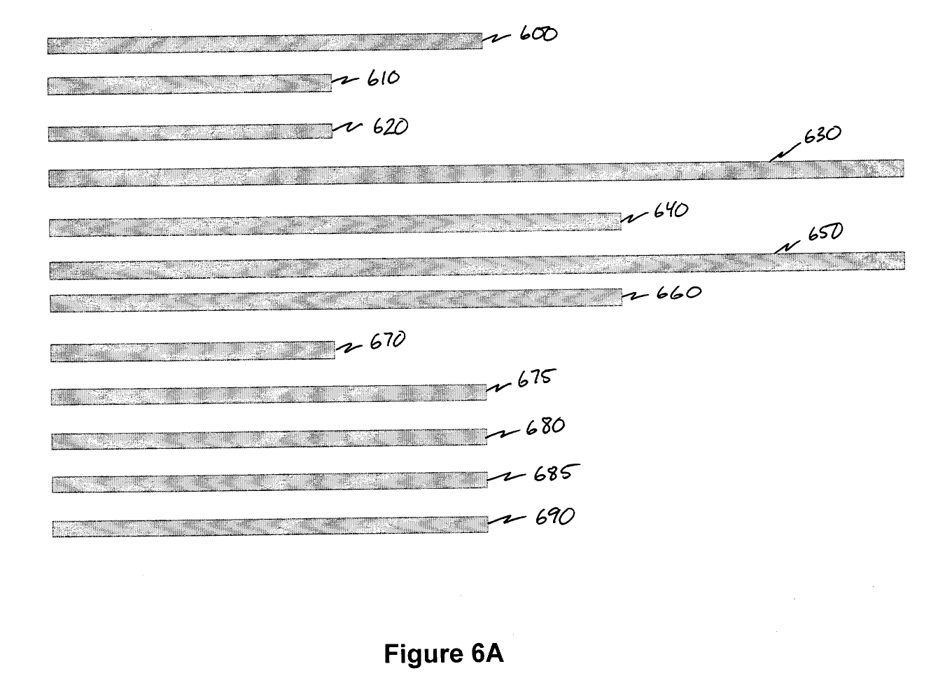

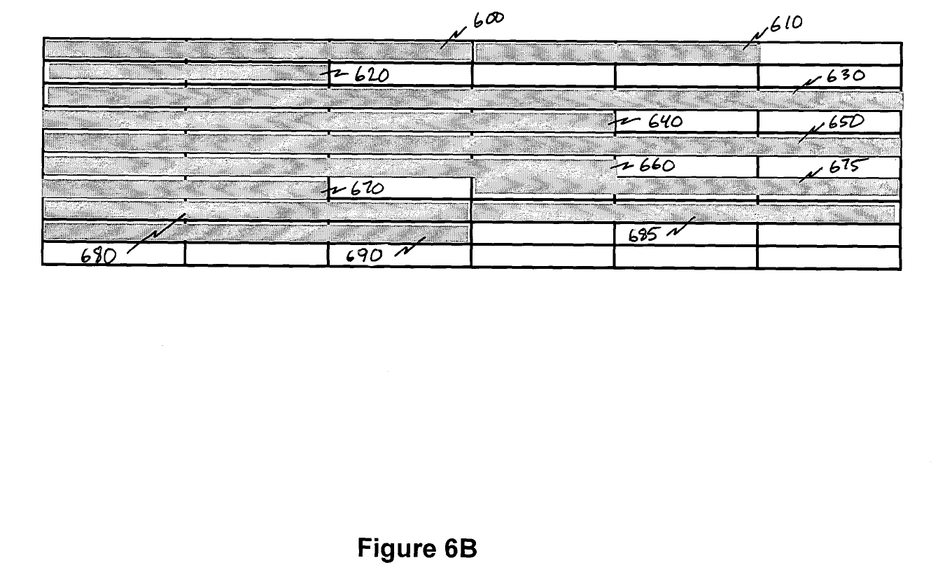

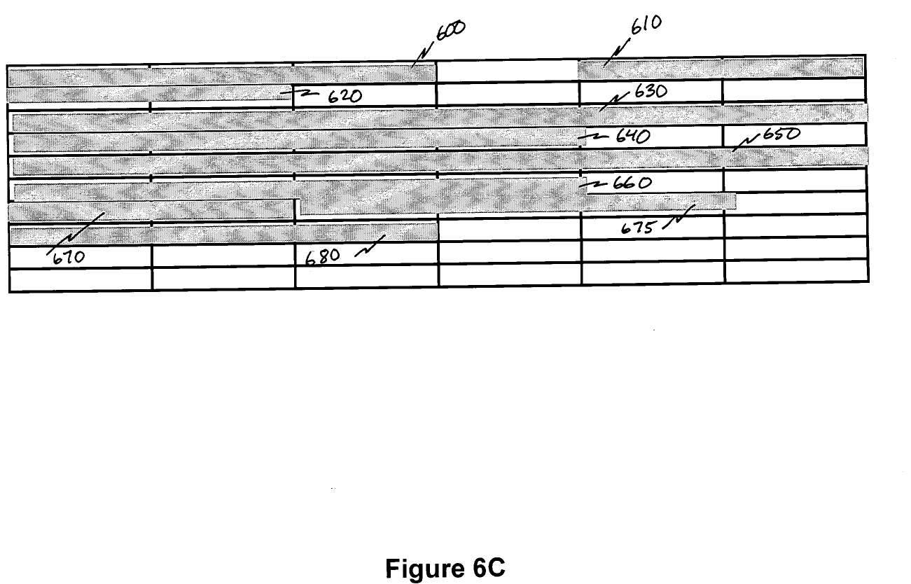

Another example of placing elements 42 in the grid 400 will now be described with reference to FIGS. 6A and B, and again to FIG. 5. FIG. 6A shows elements 600-690 that are to be placed in the empty layout 400. Beginning the process of FIG. 5 with step 500, this inquiry is answered in the negative. In step 510, the answer is no because elements 600 (three cells wide), 630 (six cells), 640 (four cells), 650 (six cells), 660 (four cells), as well as 675, 680, 685 and 690 (each three cells wide) are all “3+ elements.”

In step 520, the answer to the inquiry is no because the “4+ elements” are four: 630, 640, 650 and 660. In step 550, then, the LGM 38 determines whether three or less of the elements 42 are exactly three cells wide. Such elements are referred to as “3 elements” in FIG. 5, in analogy with the “3+ elements” mentioned earlier. The inquiry in step 550 is answered in the negative because elements 600, 675, 680, 685 and 690 are all “3 elements”. In step 560, therefore, the LGM 38 places the “4+ elements” on separate rows, as is seen in FIG. 6B, and the remaining elements 42 row-wise in two columns. Particularly, element 600 is placed in the first column and the element 610 is placed in the second column. Element 620 is placed in the first column below element 600. Elements 630, 640, 650 and 660 are placed on separate rows, and elements 670-690 are placed consecutively in the first and second columns.

The LGM 38 need not access the elements 42 repeatedly to make the determinations in steps 510, 520 and 550. Rather, the LGM may determine the sizes of all the elements 42, store the size distribution in a suitable table in ROM 22, and thereafter refer to the table during the process in FIG. 5.

Had there been at most three “3 elements” among the elements 42, the answer to the inquiry in step 550 would have been yes, and the LGM 38 would have placed the elements according to step 570. In this step, “4+ elements” are placed on separate rows, and other elements row-wise in three columns. Assume, as an example of such a scenario, that the elements 42 in FIG. 6A did not include elements 685 and 690. Per step 570, the LGM 38 would distribute the “4+ elements” on separate rows and the other elements row-wise in three columns. FIG. 6C shows the resulting layout 400 with this distribution. Particularly, element 670 is placed in the first column below element 660, and element 675 is placed in the second column. Because element 675 extends into the third column, element 680 is placed in the first column on the following row. As another example, if there had been only two “3+ elements”—elements 600 and 630 in FIG. 6A, for example—the inquiry in step 510 would have been answered in the affirmative. In step 575, the LGM 38 would have placed each “3+ element” in a separate row. The other elements would have been placed row-wise in three columns, in analogy with how elements were placed in three columns in FIG. 6C.

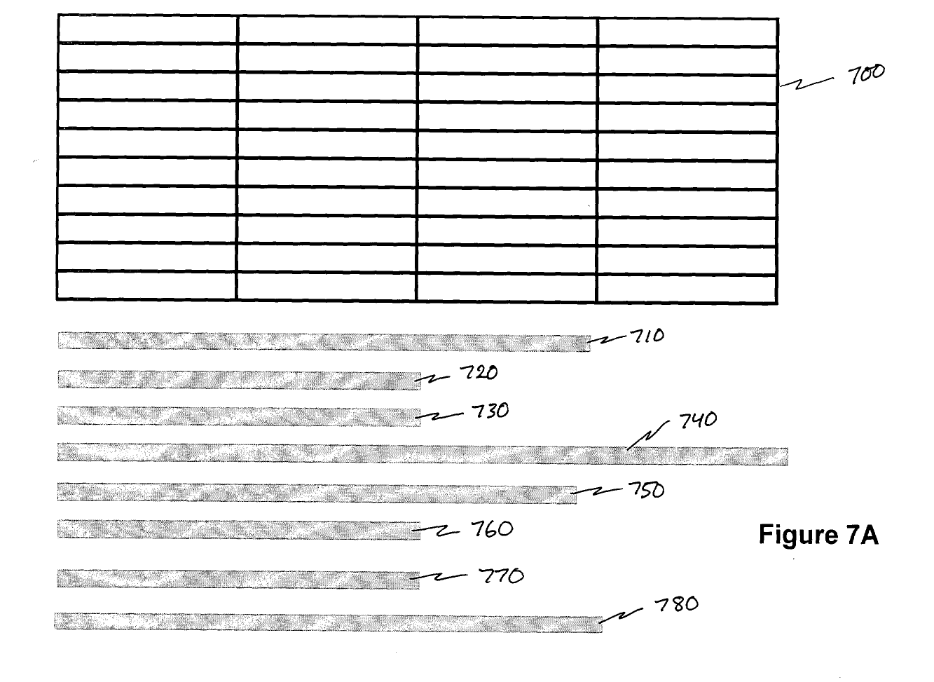

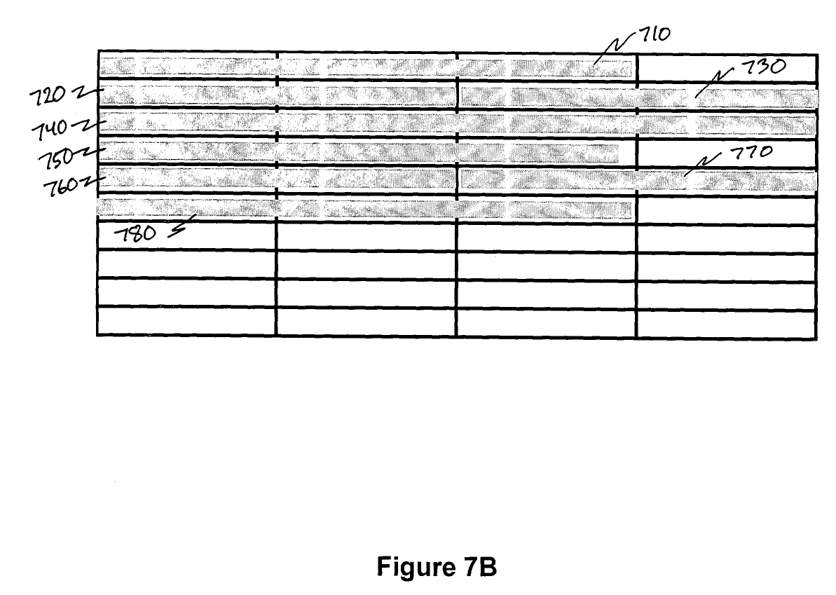

FIG. 7A shows another example that involves a four-cell layout 700. Elements 710-780 are to be placed in the layout 700. Referring again to FIG. 5, the inquiry in step 500 is whether the layout is less than six cells wide. The answer in this example is yes, so the LGM 38 in step 580 inquires whether the layout is less than four cells wide. Here, the answer is in the negative, so the elements are placed row-wise in two columns in step 590. FIG. 7B shows the resulting layout 700. Element 710 is placed in the first column. Because element 710 extends into the second column, the next element is placed below element 710 in the first column. Elements 720 and 730 are placed in the first and second columns, respectively. Element 740 is then placed in the first column below element 720 and, because it extends into the second column, the next element 750 is placed in the first column below element 740. For similar reasons, element 760 is placed in the first column and the element 770 is placed next to it in the second column. The LGM 38 places the element 780 in the first column below element 760. Had the layout been less than four cells wide, the answer to the inquiry in step 580 would have been yes, and the elements would have been placed in one column in step 595.

Thus, it can be seen that, for layouts of different sizes involving various distributions of element sizes, embodiments of the invention properly place the elements in the layout.

It is sometimes desirable to keep groups of elements together during the layout generation and in the resulting layout. This can be done by placing elements that belong together in group boxes. A group box will keep its elements together in the layout, such that they are not inadvertently mixed with other layout elements. A developer may place layout elements in a group box during the process of identifying the elements for a layout. However, as will be described below, the group boxes and the layout elements may be distributed in the layout at different stages of the layout generation process. Thus, while a group box serves to keep elements together in the layout, the elements and the group box can be handled separately before completing the layout.

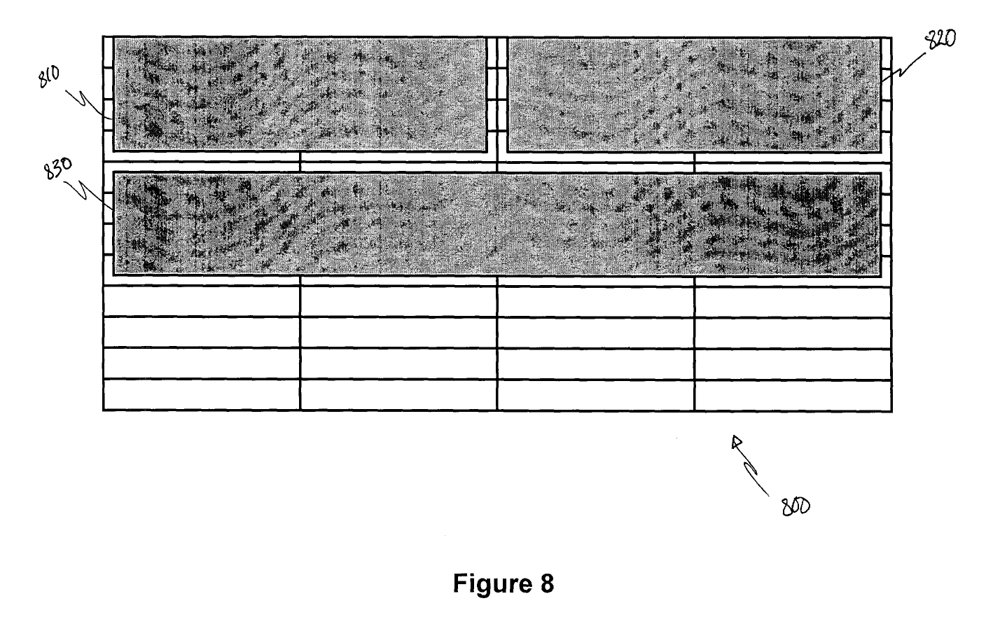

FIG. 8 shows an exemplary layout 800 provided with group boxes 810, 820 and 830. The sizes of group boxes 810 and 820 allow them to be placed side-by-side in the layout 800. The group box 830 extends the full width of the four-cell layout 800 and may hold layout elements that are up to four cells wide. The group boxes in FIG. 8 are shown without layout elements.

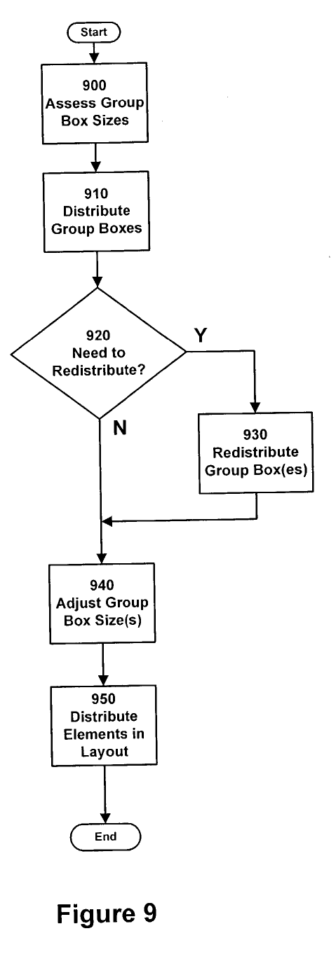

FIG. 9 is an exemplary flowchart for a procedure of distributing group boxes and layout elements in a layout. This process may be carried out by the LGM 38 when generating a layout. In step 900, the LGM determines the required sizes of the group boxes. For example, if a developer decides to place four elements in a group box, the group box must be wide enough to hold the longest of the elements. Similarly, the required height of a group box depends on the elements to be included. Referring to FIG. 8, the sizes of the group boxes 810, 820 and 830 are determined in step 900.

More specifically, the LGM may determine the required size of a group box as follows. The LGM may first determine the widths of all elements to be included in a group box and register the greatest width. This greatest width is then the minimum required width for this group box. To determine the height of the group box, the LGM may assume that all elements are placed column-wise in the group box, i.e., no elements placed side-by-side. The height thus determined may not be the height that the group box will ultimately have when placed in the layout, because some elements may then be placed side-by-side. Nevertheless, the LGM makes this initial height determination as part of assessing the size of each group box.

Knowing the sizes of the group boxes, the LGM distributes the group boxes in the layout in step 910. Typically, this involves placing the group boxes row-wise in the layout until all group boxes have been distributed. For example, FIG. 8 shows how the three group boxes 810, 820 and 830 are distributed in the layout 800.

In step 920, the LGM queries whether one or more group boxes should be redistributed in the layout. The LGM may take into account different concerns in this decision. Examples of such concerns are minimizing the use of screen space, increasing user friendliness, and improving a visual symmetry of the layout. The LGM may attempt to minimize the use of screen space when the layout otherwise would not fit on the display 16 (FIG. 1) without forcing the user to scroll the screen vertically. When the sizes and numbers of group boxes are such that they will fit on the display 16 without vertical scrolling, the LGM may redistribute one or more group boxes to improve the symmetry of the layout. If redistribution is needed in step 920, the LGM carries it out in step 930.

In step 940, the LGM may adjust the sizes of one or more group boxes. For example, the width of a group box may be increased so that the group box extends to the edge of the available screen area. Another example is extending the height of one or more group boxes such that all group boxes placed side-by-side in the layout have the same height. The elements are distributed in the layout in step 950, meaning that elements that belong in group boxes are placed there, and other elements, if any, are placed elsewhere in the layout.

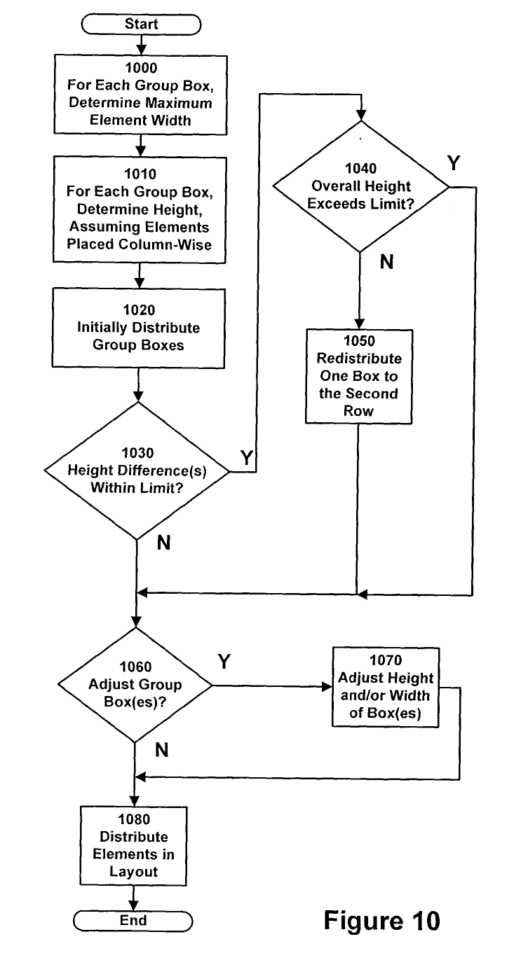

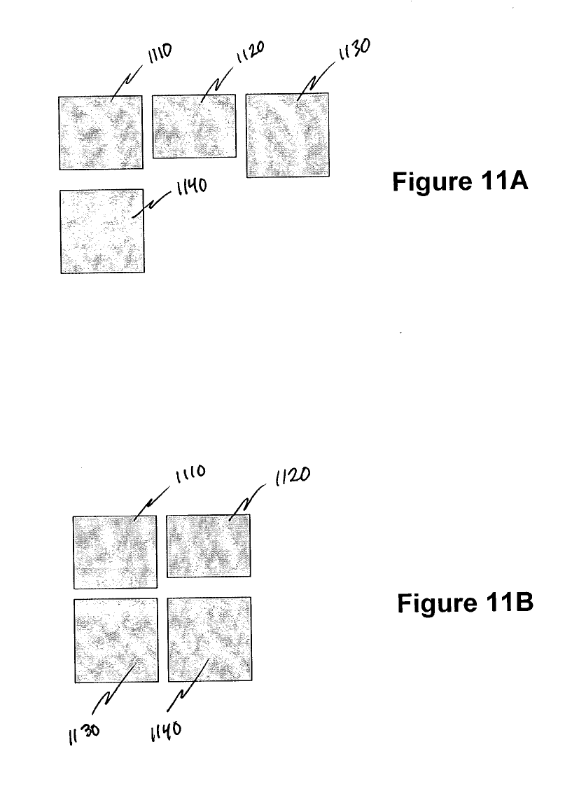

FIG. 10 is another exemplary flow chart for a procedure of distributing group boxes and layout elements in a layout, and will be described with reference also to the exemplary layouts in FIGS. 11A-B and 12A-B. The process of the LGM begins at step 1000 with determining the maximum element width for each group box. As described above, this gives the minimum required width of the group box. In step 1010, the LGM determines the required height of each group box, assuming that the elements will be placed column-wise in the group box. Thus, the LGM may determine the size of each group box by determining its width and height in these steps.

In step 1020, the LGM makes an initial distribution of the group boxes in the layout. FIG. 11A shows an example of an initial distribution of group boxes 1110, 1120, 1130 and 1140. The three former group boxes are distributed side-by-side on a first row, and the fourth is the sole group box beneath them.

In step 1030, the LGM determines the height differences, if any, between group boxes, to evaluate whether redistribution of one or more group boxes may be appropriate. Step 1030 may involve criteria such as height differences between group boxes that could end up being placed in the same row. For example, to decide whether the group box 1130 should be redistributed next to group box 1140, the LGM may determine the height differences between the two tallest boxes in each row of such a distribution. The height difference between the group boxes 1110 and 1120, which would be located on a first row of such a distribution, is determined. Also, the height difference between group boxes 1130 and 1140, which would be placed on the second row of such a distribution, is determined. Had there been more than two boxes on one or more rows of such an assumed distribution, the height difference between only the two tallest group boxes would have been considered in this example. The LGM is provided with a predetermined limit of height differences in view of the circumstances of the embodiment.

In an embodiment intended to generate layouts for a standard 1024×786 pixel screen, a height difference of at most two cells has been found useful. Thus, with reference to the group boxes in FIG. 11A, if group boxes 1110 and 1120 have at most two cells' difference in height, and the same for group boxes 1130 and 1140, the answer to the inquiry in step 1030 is yes.

In other embodiments, the LGM may take into account height differences between all group boxes. The inquiry in step 1030 would then be answered in the affirmative only if the height differences between all pairs of group boxes are within the limit. Conversely, if the height difference between at least two group boxes exceeds the limit, the answer in step 1030 is no. As another example, the LGM may take into account height differences between adjacent group boxes. The answer to the inquiry in step 1030 would then be yes only if the height differences between all adjacent group boxes are within the limit.

If the height differences meet the predetermined limit, the LGM calculates how tall the redistributed layout would be in step 1040. If this height does not exceed a predetermined limit, the LGM then chooses the redistributed layout in step 1050. FIG. 11B shows a redistributed layout where group boxes 1130 and 1140 are situated next to each other.

In the embodiment for a 1024×786 pixel screen mentioned above, a height criterion of ten cells has been found useful. Thus, if the overall height of the layout distribution in FIG. 11B is at most ten cells high, this distribution should be used. The answer in step 1040 is then no, and in step 1050 the LGM places the group boxes according to the FIG. 1l B. Had any criteria not been met in steps 1030 or 1040, the LGM would have kept the distribution shown in FIG. 11A.

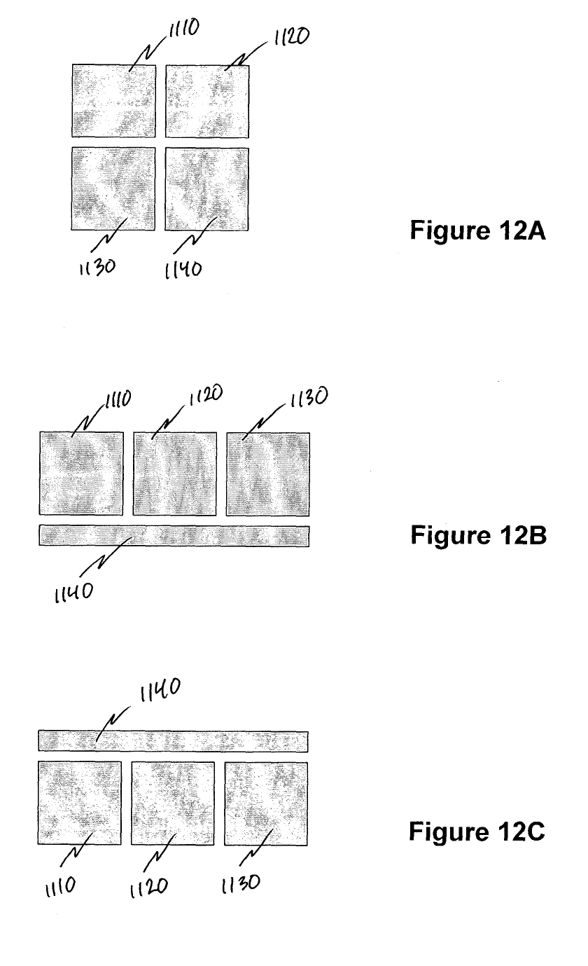

In step 1060, the LGM queries whether the size of one or more group boxes should be adjusted. Group boxes may be adjusted by height and/or width. FIG. 12A shows the result of adjusting sizes of the group boxes in FIG. 1B. As seen in FIG. 11B, group box 1120 is not as tall as group box 1110, which is located next to it. Group box 1120 is therefore adjusted in step 1070 to the same height as group box 1110 (FIG. 12A). The group boxes 1130 and 1140 in FIG. 11B are equally tall, so they may remain unadjusted in FIG. 12A.

For completeness, FIG. 12B shows the result of step 1070 when applied to the group boxes in FIG. 11A. Size-adjustment of this set of group boxes may occur when redistribution is precluded by the inquiry in either of steps 1030 or 1040. In FIG. 12B, group boxes 1110 and 1120 have been adjusted to the same height as group box 1130. Also, the group box 1140 has been adjusted to the total width of the three group boxes above it. This may cause the height of group box 1140 to diminish.

It can be seen that the FIG. 12B distribution occupies less vertical screen space than the one in FIG. 12A. Accordingly, when it is desirable to keep the layout(s) short, the predetermined limits in steps 1030 and 1040 may be set to favor distributions such as the one in FIG. 11A (and consequently the size-adjusted one in FIG. 12B). For example, setting a low limit on height differences in step 1030, and/or a low limit on overall height in step 1050, may increase the efficiency of screen space usage. A more space-efficient layout may also reduce or eliminate the need for a user to vertically scroll the display.

The FIG. 12A redistribution, on the other hand, may be considered more symmetric than the others. Thus, favoring this redistribution may increase the overall symmetry of the generated layout, which may be advantageous. To increase the chance of a symmetric layout, the height-difference limit in step 1030 and the limit on overall height in step 1040 should be set at higher values, such that there is a greater chance that a layout will fall within the limits.

Algorithms may also avoid generating undesirable layouts. Generally, a layout should not suggest relationships between elements where there are none, and the same applies to group boxes. Moreover, unnecessary implications that some elements are more important than others should be avoided. FIG. 12C illustrates how the four group boxes 11 10-40 of FIG. 11A may have appeared after the adjusting step 1060 if the group box 1140 had been the first of the four. Here, group box 1140 may appear like a header above the other three group boxes although such a relationship was not intended by the developer. Unintended relational implications like this are sometimes referred to as “misleading semantics” and may render layouts less useful. Accordingly, the algorithm may be provided with criteria that characterize undesired layouts and apply those to determine if one or more group boxes should be redistributed to avoid misleading semantics in the layout. An example of such a criterion is to avoid a single group box at the top of a layout.

It was described above with reference to FIG. 1 that system 10 may store generated layouts 40 in ROM 22. Layouts may also be output using output device(s) 18. Device 18 may include a connection to one or more computers. For example, a layout generated in the system 10 may be output to a server using device 18, on which server the layout will be used together with its intended application program 34, 36, etc. Thus, a generated layout may be used on a device that does not include the LGM 38.

A number of embodiments of the invention have been described. Nevertheless, it will be understood that various modifications may be made without departing from the spirit and scope of the invention. Accordingly, other embodiments are within the scope of the following claims.

I claim:

1. A method of generating a layout for a computer user interface comprising:
receiving a plurality of elements to be placed in a layout; and
distributing the elements in the layout according to an algorithm taking into account sizes of the elements and a size of the layout.

2. The method of claim 1, wherein a user provides the plurality of elements to generate a layout for an existing computer user interface.

3. The method of claim 1, wherein, if there are at most three elements that are wider than one-third of the layout, these at most three elements are distributed on separate rows, and the remaining elements are distributed row-wise in the layout in three columns.

4. The method of claim 1, wherein, if there are at least four elements that are wider than one-third of the layout, and if there are at most three elements that are wider than half the layout, these at most three elements are distributed on separate rows, and the remaining elements are distributed row-wise in the layout in two columns.

5. The method of claim 1, wherein at least one element comprises a label and a field, the label being located to the left of the field in the layout.

6. The method of claim 1, comprising distributing the elements row-wise if the layout is wider than a predetermined width.

7. The method of claim 6, wherein the predetermined width is related to a standard unit width for the elements.

8. The method of claim 1, further comprising receiving a plurality of group boxes to be placed in the layout, the group boxes to include groups of the plurality of elements, and distributing the group boxes in the layout.

9. The method of claim 8, wherein the algorithm comprises distributing the group boxes row-wise in the layout.

10. The method of claim 8, wherein the algorithm comprises taking into account sizes of the group boxes.

11. The method of claim 8, further comprising redistributing at least one group box to symmetrize the plurality of group boxes.

12. The method of claim 11, further comprising redistributing at least one group box to avoid misleading semantics in the layout.

13. The method of claim 8, further comprising determining whether to redistribute at least one group box.

14. The method of claim 13, further comprising redistributing at least one group box to reduce a cumulative size of the plurality of group boxes in the layout.

15. The method of claim 13, wherein the algorithm takes into account differences in height between at least two group boxes.

16. The method of claim 15, wherein the algorithm redistributes a group box from a first row to a second row if the group box fits on the second row and if the difference in height between group boxes on the first row and the difference in height between group boxes on the second row are less than a predetermined amount.

17. A method of generating a layout for a computer user interface comprising:
receiving a plurality of elements to be placed in a layout, the plurality of elements including a plurality of group boxes, wherein groups of the elements are to be placed in the group boxes;
distributing the group boxes in the layout according to a first algorithm taking into account sizes of the group boxes and a size of the layout; and
distributing the elements in the layout according to a second algorithm taking into account sizes of the elements and a size of the layout, including distributing the groups of elements in the group boxes.

18. The method of claim 17, wherein the first algorithm redistributes a group box from a first row to a second row if the group box fits on the second row and if the difference in height between group boxes on the first row and the difference in height between group boxes on the second row are less than a predetermined amount.

19. The method of claim 17, wherein, if there are at most three elements that are wider than one-third of the layout, the second algorithm distributes these at most three elements on separate rows, and distributes the remaining elements row-wise in the layout in three columns.

20. The method of claim 17, wherein, if there are at least four elements that are wider than one-third of the layout, and if there are at most three elements that are wider than half the layout, these at most three elements are distributed on separate rows, and the remaining elements are distributed row-wise in the layout in two columns.

21. Computer readable medium having stored thereon instructions for causing a digital data processing system to perform operations comprising:
receives a plurality of elements to be placed in a layout; and
distributes the elements in the layout according to an algorithm taking into account sizes of the elements and a size of the layout.

22. The medium of claim 21, further comprising receives a plurality of group boxes to be placed in the layout, the group boxes to include groups of the plurality of elements, wherein, if more than two group boxes fit side-by-side on a row in the layout, the algorithm determines whether to redistribute at least one group box.

23. The medium of claim 21, further comprising a user selecting the plurality of elements to generate a layout for an existing computer user interface.

24. A system for automatic layout generation comprising:
a plurality of elements to be placed in a layout, a width of each element being an integer multiple of a standard width; and
a layout generating module distributing the elements in the layout according to an algorithm taking into account sizes of the elements and a size of the layout.

25. The system of claim 24, further comprising a plurality of group boxes to be placed in the layout, the group boxes to include groups of the plurality of elements, wherein, if more than two group boxes fit side-by-side on a row in the layout, the layout generating module determines whether to redistribute at least one group box.

26. The system of claim 24, wherein the system includes an existing computer user interface, and wherein a user can provide the plurality of elements to the layout generating module to generate a layout for the existing computer user interface.
